(19) United States
(12) Patent Application Publication
(10) Pub. No.: US 2026/0202972 A1
(43) Pub. Date: Jul. 16, 2026

(54) MEMORY MANAGEMENT METHOD AND MEMORY CONTROLLER

(71) Applicant: Hosin Global Electronics Co., LTD, Shenzhen (CN)

(72) Inventors: Xuelou HUANG, Shenzhen (CN); Donglin CHEN, Shenzhen (CN); Wenhao Cai, Shenzhen (CN); Jinlong Wu, Shenzhen (CN); Lin Zhang, Shenzhen (CN); XiaoGang Lu, Shenzhen (CN)

(73) Assignee: Hosin Global Electronics Co., LTD, Shenzhen (CN)

(21) Appl. No.: 19/390,640

(22) Filed: Nov. 16, 2025

(30) Foreign Application Priority Data
Jan. 16, 2025 (CN) 202510071951.6

(51) Int. Cl. G06F 3/06

(52) U.S. Cl. CPC G06F 3/0616; G06F 3/0634; G06F 3/064; G06F 3/0647; G06F 3/0679

(57) ABSTRACT

A memory management method and a memory controller are provided. The method includes obtaining a first bad block and adjusting its operating mode from a first storage mode to a second storage mode with a lower storage capacity per memory cell. If the block is verified as qualified in the second storage mode, it is recorded as an adjusted block. Subsequently, according to a preset storage capacity, a plurality of such adjusted blocks are combined into a virtual spare block and incorporated into an Over-Provisioning Space. This method enables the full utilization of memory cells that fail in their original operating mode but are still usable after being downgraded, thereby effectively extending the service life of the storage device.

### CROSS-REFERENCE TO RELATED APPLICATION

This application claims the priority benefit of China application serial no. 202510071951.6, filed on January 16, 2025. The entirety of the above-mentioned patent application is hereby incorporated by reference herein and made a part of this specification.

### BACKGROUND

### Technical Field

The present disclosure relates to the technical field of memory technology, and more particularly, to a memory management method and a memory controller.

### Description of Related Art

Non-volatile memory refers to a computer memory in which the stored data does not disappear after power is cut off, has advantages such as data non-volatility, low power consumption, small size, and no mechanical structure, and is widely used in various electronic devices.

A common non-volatile memory is a memory configured with NAND Flash (such as a solid state drive), which has characteristics such as high read/write speed and not requiring a mechanical structure for data access.

In NAND Flash storage technology, as the usage time of the NAND Flash increases, memory cells gradually degrade, causing the number of bad blocks to increase. Specifically, after a memory cell is frequently programmed and erased, its read voltage may shift, eventually leading to the inability to correctly read data. Therefore, it is necessary to record or verify the number of Program/Erase cycles (P/E cycles) or the number of Error Correction Code (ECC) bits of a block. When the P/E cycle of the recorded block exceeds a threshold or the number of ECC bits exceeds a threshold, the corresponding block is determined to be a bad block.

In the related art, when a bad block is detected, a spare block is usually taken from the Over-Provisioning Space (OP space) to replace the bad block. However, since the number of spare blocks in the OP space is limited, as the number of bad blocks gradually increases, the spare blocks will be gradually used up. Once the spare blocks are exhausted, the available capacity of the storage device will be reduced, so as to affect the service life of the storage device.

### SUMMARY

In view of the above problems, the present disclosure provides a memory management method and a memory controller, which adjusts the operating mode of a bad block and reuses the bad block that is still usable after the adjustment as a spare resource, so as to improve the utilization efficiency of spare resources. The technical solution of the present disclosure is not only applicable to Triple-Level Cell (TLC) type memory cells but can also be applied to other types of multi-level memory cells such as Multi-Level Cell (MLC) or Quad-Level Cell (QLC).

One or more embodiments of the present disclosure provide a memory management method, adapted for a storage device configured with a rewritable non-volatile memory module. The method includes: obtaining a first bad block; determining whether the operating mode of the first bad block is adjustable; if the operating mode of the first bad block is adjustable: adjusting the operating mode of the first bad block from a first storage mode to a second storage mode to obtain a second bad block, wherein a first storage capacity of each first memory cell of the first bad block in the first storage mode is greater than a second storage capacity of each second memory cell of the second bad block in the second storage mode; detecting the second bad block in the second storage mode; if a detection result of the second bad block is qualified, designating the second bad block as an adjusted block and recording the adjusted block; and according to a preset storage capacity and respective storage capacities of a plurality of recorded adjusted blocks, obtaining a plurality of target adjusted blocks from the plurality of adjusted blocks, and combining the plurality of target adjusted blocks into a virtual spare block to be incorporated into the Over-Provisioning Space of the rewritable non-volatile memory module, wherein the storage capacity of the virtual spare block is equal to the preset storage capacity.

One or more embodiments of the present disclosure provide a memory controller for controlling a storage device configured with a rewritable non-volatile memory module. The memory controller includes: a memory interface control circuit, for electrically connecting to the rewritable non-volatile memory module; a data management circuit, electrically connected to a connection interface circuit of the storage device, for receiving data and commands from a host system via the connection interface circuit; a buffer memory, for buffering data; and a processor, electrically connected to the memory interface control circuit, the data management circuit, and the buffer memory. The processor is configured to: obtain a first bad block; determine whether the operating mode of the first bad block is adjustable; if the operating mode of the first bad block is adjustable: adjust the operating mode of the first bad block from a first storage mode to a second storage mode to obtain a second bad block, wherein a first storage capacity of each first memory cell of the first bad block in the first storage mode is greater than a second storage capacity of each second memory cell of the second bad block in the second storage mode; detect the second bad block in the second storage mode; if a detection result of the second bad block is qualified, designate the second bad block as an adjusted block and record the adjusted block; and according to a preset storage capacity and respective storage capacities of a plurality of recorded adjusted blocks, obtain a plurality of target adjusted blocks from the plurality of adjusted blocks, and combine the plurality of target adjusted blocks into a virtual spare block to be incorporated into the Over-Provisioning Space of the rewritable non-volatile memory module, wherein the storage capacity of the virtual spare block is equal to the preset storage capacity.

Based on the above, the memory management method and the memory controller provided by the embodiments of the present disclosure can make full use of the memory cells that cannot work properly in the original operating mode but are still usable after being downgraded. Specifically, by adjusting the operating mode of a bad block from a high storage density to a low storage density (for example, from TLC to MLC or SLC) and verifying its availability after the adjustment, the memory cells originally determined as bad blocks are effectively utilized. In addition, the present disclosure combines a plurality of adjusted blocks into a virtual spare block to effectively supplement the spare resources in the OP space, so as to slow down the consumption rate of the original spare blocks in the OP space. For a bad block that still cannot work completely properly in the lowest storage mode, the present disclosure extracts the qualified physical pages therein and uses them in combination, thereby further improving the utilization efficiency of storage resources. Since the technical solution provided by the present disclosure can extend the available time of spare blocks, the service life of the storage device is correspondingly extended, and the reliability of the storage device is improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram of a host system and a storage device according to an embodiment of the present disclosure.

FIG. 2 is a schematic flowchart of a memory management method according to an embodiment of the present disclosure.

FIG. 3 is a schematic flowchart of a method for determining whether the operating mode of a first bad block is adjustable according to another embodiment of the present disclosure.

FIG. 4 is a schematic flowchart of a method for determining whether the operating mode of a first bad block is adjustable according to yet another embodiment of the present disclosure.

FIG. 5 is a schematic flowchart of a method for determining whether the operating mode of a first bad block is adjustable according to still another embodiment of the present disclosure.

FIG. 6 is a schematic flowchart of a processing method when the operating mode of a first bad block is not adjustable according to an embodiment of the present disclosure.

FIG. 7 is a schematic diagram of an operating mode adjustment process of a physical block according to an embodiment of the present disclosure.

FIG. 8 is a schematic diagram of a qualified physical page extraction process in a bad block according to an embodiment of the present disclosure.

FIG. 9 is a first exemplary schematic diagram of a construction process of a virtual spare block according to an embodiment of the present disclosure.

FIG. 10 is a schematic diagram of an adjusted block list and a virtual spare block mapping table according to an embodiment of the present disclosure.

FIG. 11 is a second exemplary schematic diagram of a construction process of a virtual spare block according to an embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

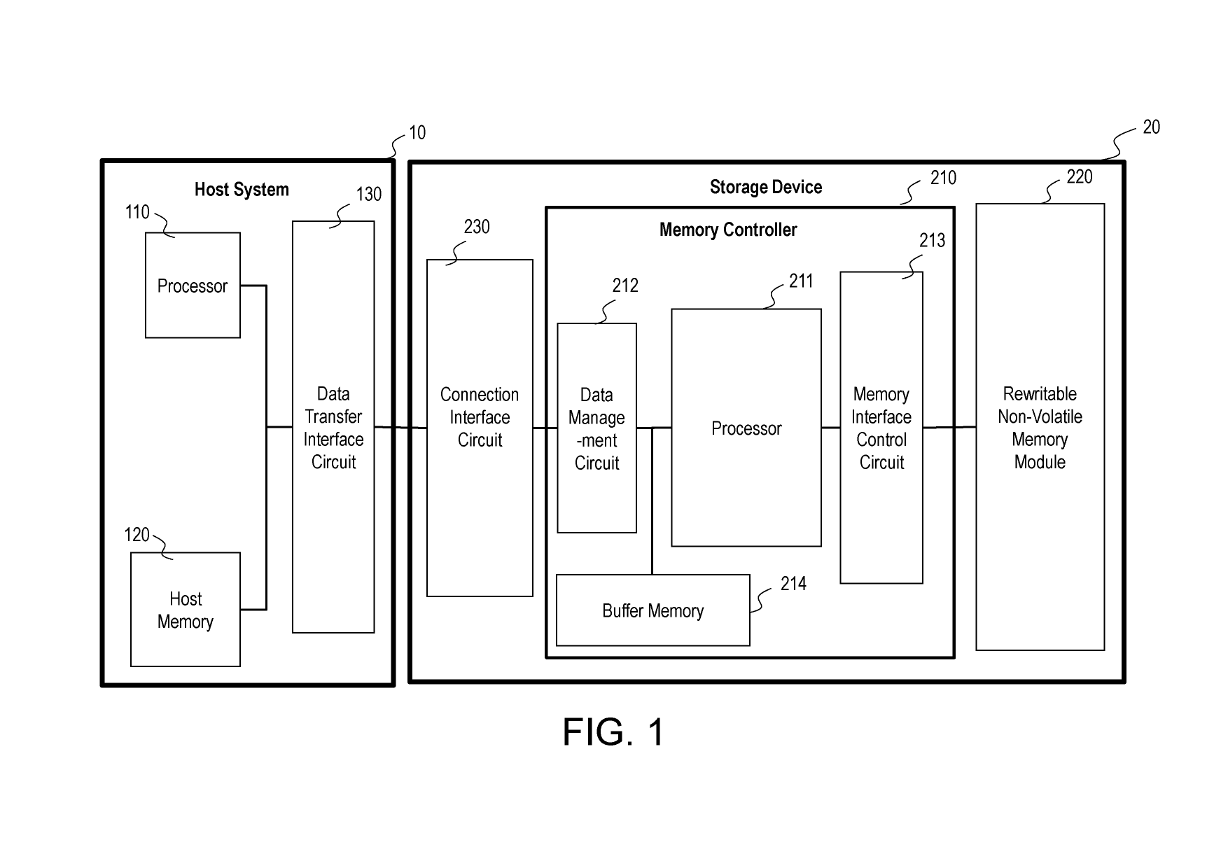

FIG. 1 is a schematic block diagram of a host system and a storage device according to an embodiment of the present disclosure. Referring to FIG. 1, the host system 10 is, for example, a personal computer, a notebook computer, or a server. The host system 10 includes a processor 110 (also referred to as a second processor), a host memory 120, and a data transfer interface circuit 130. In this embodiment, the processor 110 is coupled (also referred to as electrically connected) to the host memory 120 and the data transfer interface circuit 130. In another embodiment, the processor 110, the host memory 120, and the data transfer interface circuit 130 are electrically connected to each other by a system bus. In this embodiment, the processor 110, the host memory 120, and the data transfer interface circuit 130 may be disposed on a motherboard of the host system 10.

The storage device 20 includes a memory controller 210, a rewritable non-volatile memory module 220, and a connection interface circuit 230. The memory controller 210 includes a processor 211 (also referred to as a first processor), a data management circuit 212, and a memory interface control circuit 213.

In this embodiment, the host system 10 is electrically connected to the storage device 20 through the data transfer interface circuit 130 and the connection interface circuit 230 of the storage device 20 to perform data access operations. For example, the host system 10 may store data to the storage device 20 or read data from the storage device 20 via the data transfer interface circuit 130.

In this embodiment, the number of the data transfer interface circuits 130 may be one or more. Through the data transfer interface circuit 130, a motherboard may be electrically connected to the storage device 20 via a wired or wireless manner. The storage device 20 may be, for example, a USB flash drive, a memory card, a solid state drive (SSD), or a wireless memory storage device. The wireless memory storage device may be, for example, a Near Field Communication (NFC) memory storage device, a Wi-Fi memory storage device, a Bluetooth memory storage device, or a Bluetooth Low Energy memory storage device (for example, iBeacon), or other memory storage devices based on various wireless communication technologies. In addition, the motherboard may also be electrically connected to various I/O devices such as a Global Positioning System (GPS) module, a network interface card, a wireless transmission device, a keyboard, a screen, and a speaker through the system bus.

In this embodiment, the data transfer interface circuit 130 and the connection interface circuit 230 are interface circuits compatible with the Peripheral Component Interconnect Express (PCI Express) standard. In addition, data transmission between the data transfer interface circuit 130 and the connection interface circuit 230 is performed using the Non-Volatile Memory express (NVMe) communication protocol.

In addition, in another embodiment, the connection interface circuit 230 may be packaged with the memory controller 210 in a single chip, or the connection interface circuit 230 is disposed outside a chip including the memory controller 210.

In this embodiment, the host memory 120 is used to temporarily store commands or data executed by the processor 110. For example, in this embodiment, the host memory 120 may be a dynamic random access memory (DRAM), a static random access memory (SRAM), or the like. However, it should be understood that the present disclosure is not limited thereto, and the host memory 120 may also be other suitable memories.

The memory controller 210 is for executing a plurality of logic gates or control commands implemented in a hardware form or a firmware form and performing data writing, reading, and erasing operations in the rewritable non-volatile memory module 220 according to commands from the host system 10.

More specifically, the processor 211 in the memory controller 210 is a hardware with computing capabilities, for controlling the overall operation of the memory controller 210. Specifically, the processor 211 is programmed by a plurality of control commands/program codes, and when the storage device 20 operates, these control commands/program codes are executed to perform data writing, reading, and erasing operations. In addition, in this embodiment, the control commands/program codes may be further executed to implement the memory management method provided by the present disclosure. The control commands/program codes corresponding to the memory management may be further implemented as circuit units in a hardware form to implement the memory management method provided by the present disclosure.

It is worth mentioning that, in this embodiment, the processor 110 and the processor 211 are, for example, a central processing unit (CPU), a microprocessor, or other programmable processing unit (Microprocessor), a digital signal processor (DSP), a programmable controller, an application specific integrated circuit (ASIC), a programmable logic device (PLD), or other similar circuit components, and the present disclosure is not limited in this regard.

In this embodiment, as described above, the memory controller 210 further includes the data management circuit 212 and the memory interface control circuit 213. It should be noted that operations performed by each component of the memory controller 210 may also be regarded as operations performed by the memory controller 210.

The data management circuit 212 is electrically connected to the processor 211, the memory interface control circuit 213, and the connection interface circuit 230. The data management circuit 212 is for receiving instructions from the processor 211 to perform data transmission. For example, reading data from the host system 10 (e.g., the host memory 120) via the connection interface circuit 230, and writing the read data to the rewritable non-volatile memory module 220 via the memory interface control circuit 213 (e.g., performing a write operation according to a write command from the host system 10). As another example, reading data from one or more physical units of the rewritable non-volatile memory module 220 via the memory interface control circuit 213 (data may be read from one or more memory cells in the one or more physical units), and writing the read data to the host system 10 (e.g., the host memory 120) via the connection interface circuit 230 (e.g., performing a read operation according to a read command from the host system 10). In another embodiment, the data management circuit 212 may also be integrated into the processor 211.

The memory interface control circuit 213 is for receiving instructions from the processor 211 and cooperating with the data management circuit 212 to perform write (also referred to as programming), read, or erase operations on the rewritable non-volatile memory module 220.

In addition, data to be written to the rewritable non-volatile memory module 220 is converted via the memory interface control circuit 213 into a format acceptable to the rewritable non-volatile memory module 220. Specifically, if the processor 211 is to access the rewritable non-volatile memory module 220, the processor 211 sends a corresponding command sequence to the memory interface control circuit 213 to instruct the memory interface control circuit 213 to perform a corresponding operation. For example, these command sequences may include a write command sequence for instructing to write data, a read command sequence for instructing to read data, an erase command sequence for instructing to erase data, and corresponding command sequences for instructing various memory operations. These command sequences may include one or more signals, or data on a bus. These signals or data may include command codes or program codes. For example, in a read command sequence, information such as a read identifier, a memory address, and a physical address is included.

In the present disclosure, the memory controller 210 establishes a Logical-To-Physical address mapping table and a Physical-To-Logical address mapping table to record the mapping relationship between logical addresses of logical units (e.g., logical blocks, logical pages, or logical rows) configured for the rewritable non-volatile memory module 220 and physical addresses of physical units (e.g., physical erase units/physical blocks, physical pages, physical rows). In other words, the memory controller 210 may look up a physical unit mapped to a logical unit (e.g., look up a physical page mapped to a logical page; look up a physical address mapped to a logical address) through the Logical-To-Physical address mapping table (also referred to as a logical-to-physical mapping table), and the memory controller 210 may look up a logical unit mapped to a physical unit (e.g., look up a logical page mapped to a physical page; look up a logical address mapped to a physical address) through the Physical-To-Logical address mapping table (also referred to as a physical-to-logical mapping table).

The memory controller 210 also establishes data structures to record various types of mapping relationships: including establishing an adjusted block list corresponding to different storage modes for adjusted blocks, establishing a corresponding spare page group list for spare page groups, establishing a mapping table for a virtual spare block to record the correspondence relationship between it and the adjusted blocks, and establishing a mapping table for the virtual spare block to record the correspondence relationship between it and the spare page groups. When a data access operation needs to be performed on a specified virtual spare block, the memory controller 210 may obtain the actual physical address by querying these mapping tables, and then perform the corresponding data read/write operation.

In an embodiment, the memory controller 210 further includes a buffer memory 214. The buffer memory is electrically connected to the processor 211 and is for temporarily storing data and commands from the host system 10, data from the rewritable non-volatile memory module 220, or other system data for managing the storage device 20 (such as various mapping tables, index tables, address lists, the adjusted block list, the spare page group list, the virtual spare block mapping table, and other system data related to the present disclosure), so that the processor 211 may quickly access the data, commands, or system data from the buffer memory 214.

The rewritable non-volatile memory module 220 is electrically connected to the memory controller 210 (the memory interface control circuit 213) and is for storing data written by the host system 10.

In this embodiment, the rewritable non-volatile memory module 220 has a plurality of word lines, wherein each of the plurality of word lines is electrically connected to a plurality of memory cells, also referred to as a row (also referred to as a physical row). A plurality of rows on the same word line form a physical programming unit (also referred to as a physical page). Each physical page corresponds to a physical address for recording the location of the data stored in the physical page. In addition, a plurality of physical pages may form a physical block (also referred to as a physical erase unit or a physical block). Each of a plurality of memory dies (chips) of the rewritable non-volatile memory module has a plurality of planes, and each plane has a plurality of physical blocks. It should be noted that the present disclosure is not limited to the size of each physical page and logical page.

The memory cell type (also referred to as storage mode) may be used to represent the number of bits that can be stored in each memory cell. Common types include Single-Level Cell (SLC) (each memory cell stores 1 bit), Multi-Level Cell (MLC) (each memory cell stores 2 bits), Triple-Level Cell (TLC) (each memory cell stores 3 bits), and the like. Different storage modes differ in terms of storage density, read/write speed, and endurance, affecting the overall performance and characteristics of the NAND Flash. In addition, in this embodiment, each physical block may be set to a different operating mode, and the memory cells it has are respectively set to different storage modes. For example, when the operating mode of a physical block is set to the TLC storage mode, each memory cell it has can store 3 bits. When the storage mode of this physical block is adjusted from the TLC storage mode to the SLC or MLC storage mode, the number of bits that can be stored in each memory cell of this physical block is adjusted to 1 bit or 2 bits.

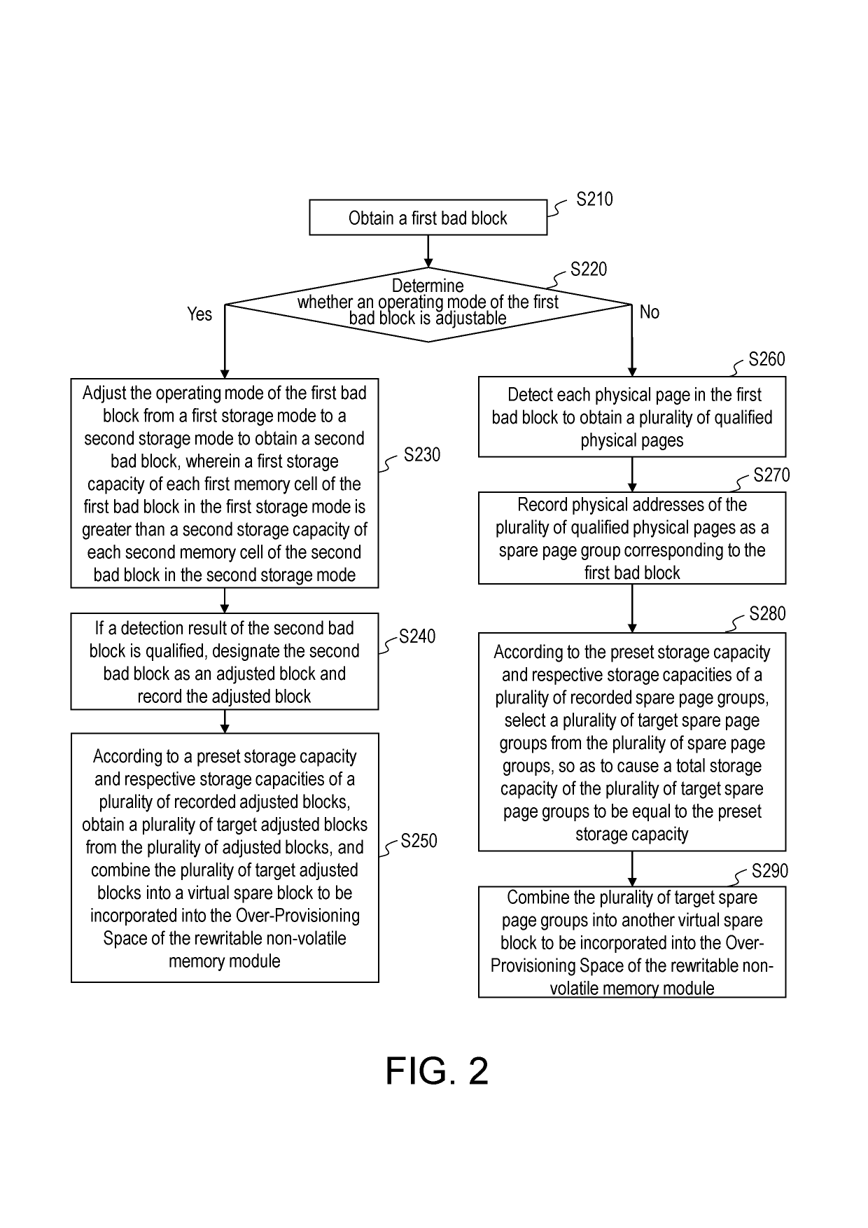

FIG. 2 is a schematic flowchart of a memory management method according to an embodiment of the present disclosure.

Referring to FIG. 2, in an embodiment, a processor of the memory controller 210 executes a plurality of program modules to perform a memory management method.

In step S210, the memory controller 210 obtains a first bad block. Specifically, the memory controller 210 may obtain the first bad block by periodically detecting the status of each physical block in a data area of the rewritable non-volatile memory module 220. For example, in an embodiment, the memory controller 210 may detect a Program/Erase cycle (P/E cycle) value of each physical block, and when the P/E cycle of a certain physical block exceeds a first preset program/erase threshold, the physical block is determined to be the first bad block. Alternatively, in an embodiment, the memory controller 210 may verify data in each physical block and record the number of Error Correction Code (ECC) bits for each data segment, and when the number of ECC bits of a certain data segment exceeds a preset ECC bit threshold, the physical block containing the data segment is determined to be the first bad block.

In an embodiment, when obtaining a first bad block, the memory controller 210 first detects whether each physical block in a data area of the rewritable non-volatile memory module 220 meets a bad block determination criterion. These bad block determination criteria may include the detection of a plurality of parameter indicators. For example, the memory controller 210 may detect whether a program/erase cycle count of a physical block exceeds a first preset program/erase threshold, or detect whether a number of ECC bits of data in the physical block exceeds a first preset ECC bit threshold. In addition, the memory controller 210 may also monitor the read performance of the physical block to determine whether its read latency exceeds a first preset read latency threshold. The memory controller 210 may also record the write operation status of the physical block to check whether its write failure count exceeds a first preset write failure threshold. When it is detected that a certain physical block in the data area meets any of the above bad block determination criteria, the memory controller 210 determines the physical block as the first bad block. By adopting a plurality of determination criteria, the memory controller 210 can timely and accurately identify performance-degraded physical blocks, so as to provide a reliable basis for subsequent operating mode adjustment and resource reorganization.

In step S220, the memory controller 210 determines whether the operating mode of the first bad block is adjustable. In one determination method, the memory controller 210 may determine whether the operating mode of the first bad block is a lowest storage mode (for example, an SLC mode). If the operating mode of the first bad block is not the lowest storage mode, it is determined that the operating mode is adjustable; if it is the lowest storage mode, it is determined that the operating mode is not adjustable.

If the operating mode of the first bad block is adjustable, then in step S230, the memory controller 210 adjusts the operating mode of the first bad block from a first storage mode to a second storage mode to obtain a second bad block. For example, if the operating mode of the first bad block originally adopts a TLC mode, it may be adjusted to an MLC mode or an SLC mode, wherein a first storage capacity of each first memory cell of the first bad block in the first storage mode (such as the TLC mode) is greater than a second storage capacity of each second memory cell of the second bad block in the second storage mode (such as the MLC mode or the SLC mode).

Next, in step S240, the memory controller 210 detects the availability of the second bad block in the second storage mode. For example, the memory controller 210 may write test data to the second bad block and attempt to read the test data from the second bad block. If the read result of the test data is successful, it is determined that a detection result of the second bad block is qualified, and the memory controller 210 designates the second bad block as an adjusted block and records the adjusted block. In other words, the memory controller 210 considers the first bad block to have become a physical block capable of normally storing data after being downgraded, and records this situation (it is marked as an adjusted block to record that this physical block is obtained through a downgrading operation).

In an embodiment, the memory controller 210 may establish an adjusted block list, and the adjusted block list may record identification information of a first bad block and corresponding physical addresses. However, in another embodiment, the adjusted block list may also record state information of these physical pages (such as parameters like read latency and number of ECC bits of the physical page). By maintaining such a list, the memory controller 210 can more effectively manage and utilize these storage resources that can still work properly. It should be noted that the adjusted block list may also be classified according to different storage modes.

Next, in step S250, the memory controller 210, according to a preset storage capacity and respective storage capacities of a plurality of recorded adjusted blocks, obtains a plurality of target adjusted blocks from the plurality of adjusted blocks, and combines the plurality of target adjusted blocks into a virtual spare block to be incorporated into the Over-Provisioning Space of the rewritable non-volatile memory module 220. Specifically, the memory controller 210 selects a plurality of target adjusted blocks from the adjusted block list, so that a total storage capacity of these target adjusted blocks is equal to the preset storage capacity (for example, the storage capacity of an original TLC block). For example, if each adjusted block is in an SLC mode, three adjusted blocks in the SLC mode may be selected to be combined into a virtual spare block with a capacity equivalent to that of a TLC block. The preset storage capacity is, for example, the size of the storage space of a main data block in a data area of the rewritable non-volatile memory module 220.

It should be noted that the size of the virtual spare block corresponding to the preset storage capacity varies with the preset storage capacity. In other words, as the tasks of the system differ, the preset storage capacity may change accordingly, prompting the memory controller 210 to use a plurality of adjusted blocks to combine into an appropriate virtual spare block corresponding to a different preset storage capacity. In this way, the available storage space of the storage device 20 may be utilized more flexibly.

More specifically, in an embodiment, first, the memory controller 210 looks for available adjusted blocks from the adjusted block list. Based on the preset storage capacity (for example, the storage capacity of a physical block in a TLC mode) and the storage capacity of each adjusted block recorded in the adjusted block list, the memory controller 210 selects an appropriate number of target adjusted blocks, such that the total storage capacity of these target adjusted blocks is equal to the preset storage capacity. For example, the memory controller 210 may select one adjusted block in an MLC mode and one adjusted block in an SLC mode, or select three adjusted blocks in the SLC mode. Subsequently, the memory controller 210 combines the selected plurality of target adjusted blocks into a virtual spare block. Finally, the memory controller 210 incorporates the virtual spare block into the Over-Provisioning Space of the rewritable non-volatile memory module 220, and establishes a mapping relationship between the virtual spare block and these target adjusted blocks in the virtual spare block mapping table, recording identification information of the virtual spare block and physical address information of each corresponding target adjusted block, so that the actual physical locations can be correctly accessed during subsequent data access operations.

In another embodiment, before adjusting the operating mode of the first bad block from the first storage mode to the second storage mode, the memory controller 210 needs to first ensure that the valid data in the first bad block is properly saved. Specifically, the memory controller 210 first obtains an available storage space from the Over-Provisioning Space of the rewritable non-volatile memory module 220 as a first data block, and the first data block may be a normal spare block, or a virtual spare block formed by combining a plurality of adjusted blocks or a plurality of spare page groups. After obtaining the first data block, the memory controller 210 migrates the data in the first bad block to the first data block, and incorporates the first data block into a data area of the rewritable non-volatile memory module 220, while updating the corresponding address mapping relationship. Through this data migration operation, the memory controller 210 ensures the security of the original data, enabling the operating mode adjustment operation to be safely performed on the first bad block subsequently.

If it is determined in step S220 that the operating mode of the first bad block is not adjustable, then step S260 is executed.

In step S260, the memory controller 210 detects each physical page in the first bad block to obtain a plurality of qualified physical pages. Specifically, the memory controller 210 may perform detection in the following manner: first, perform a read operation on each physical page in the first bad block, and check whether the read data can pass Error Correcting Code (ECC) verification. If the data read from a certain physical page can pass the ECC verification, or its number of ECC bits is within an acceptable range (for example, the number of ECC bits per 2KB of data does not exceed a preset threshold), then the physical page is determined to be a qualified physical page.

In step S270, the memory controller 210 records the physical addresses of the obtained plurality of qualified physical pages as a spare page group corresponding to the first bad block. The memory controller 210 may establish a spare page group list, and the spare page group list may record identification information of the first bad block and corresponding physical addresses of the qualified physical pages. However, in another embodiment, the spare page group list may also record state information of these physical pages (such as parameters like read latency and number of ECC bits of the physical page). By maintaining such a list, the memory controller 210 can more effectively manage and utilize these storage resources that can still work properly.

Then in step S280, the memory controller 210, according to a preset storage capacity and respective storage capacities of a plurality of recorded spare page groups, selects a plurality of target spare page groups from these spare page groups, so that the total storage capacity of the selected target spare page groups is equal to the preset storage capacity. During the selection process, the memory controller 210 may comprehensively consider a plurality of factors: for example, preferentially selecting spare page groups containing physical pages with smaller read latencies, or preferentially selecting spare page groups from the same physical block to improve data access efficiency. In addition, the memory controller 210 may also consider the distribution of qualified physical pages in each spare page group, and select spare page groups with a relatively concentrated distribution of physical pages, so that subsequent data access operations can be more efficient.

Finally in step S290, the memory controller 210 combines the plurality of target spare page groups into another virtual spare block to be incorporated into the Over-Provisioning Space of the rewritable non-volatile memory module 220. In this process, the memory controller 210 needs to establish a mapping relationship between the virtual spare block and the target spare page groups. This mapping relationship may include: identification information of the virtual spare block (e.g., a serial number/index of the virtual spare block), identification information of the corresponding plurality of target spare page groups (e.g., a serial number/index of the corresponding target spare page groups or identification information of the corresponding physical block), and physical addresses of qualified physical pages in each target spare page group. By establishing such a mapping relationship, when a data access operation needs to be performed on the virtual spare block, the memory controller 210 can quickly locate the actual physical addresses, so as to ensure the accuracy and efficiency of the data operation.

In an embodiment, this organizational approach also facilitates dynamic management by the memory controller 210. For example, when the performance of some physical pages degrades, the mapping relationship may be timely updated, and other suitable physical pages may be selected for replacement.

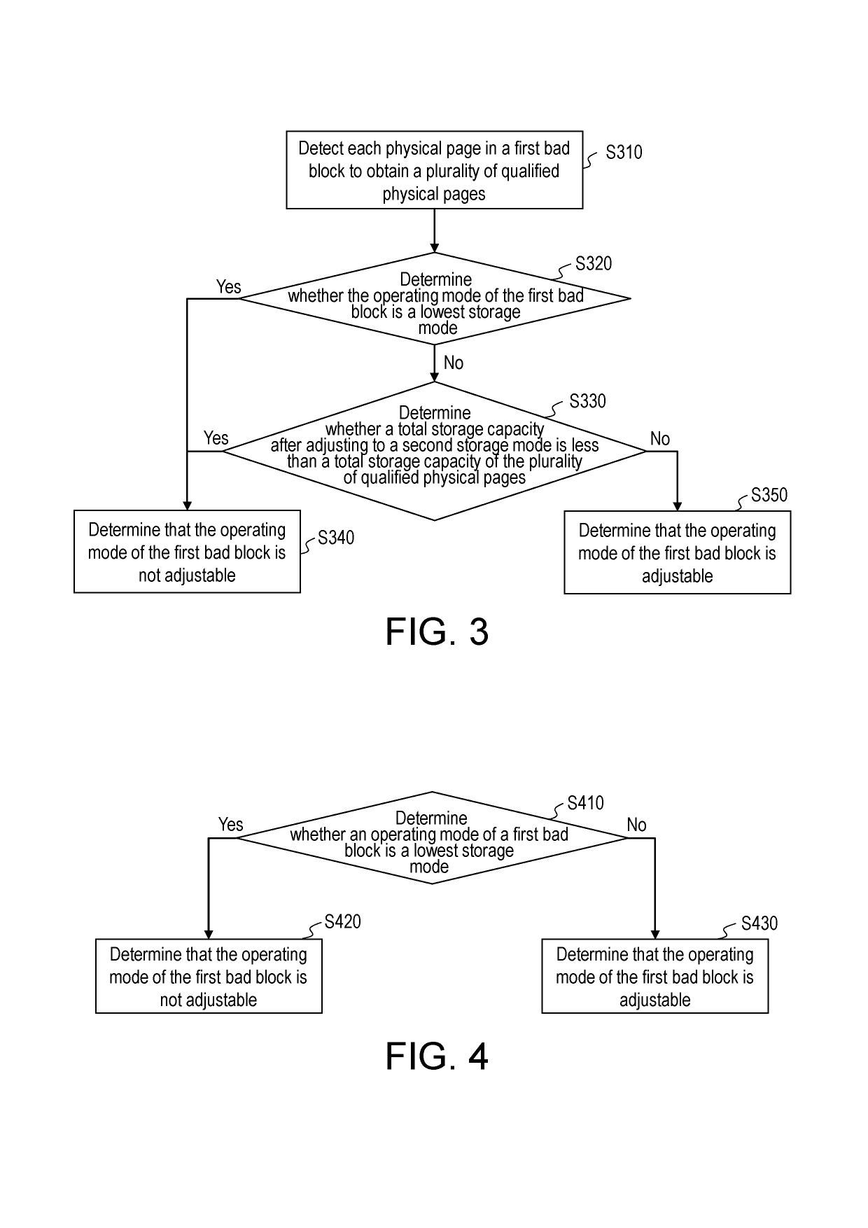

FIG. 3 is a schematic flowchart of a method for determining whether the operating mode of a first bad block is adjustable according to another embodiment of the present disclosure.

Referring to FIG. 3, in an embodiment, the memory controller 210 may determine whether the operating mode of a first bad block is adjustable in the following manner.

In step S310, the memory controller 210 first detects each physical page in the first bad block to obtain a plurality of qualified physical pages. Specifically, the memory controller 210 may perform a read operation on each physical page in the first bad block, and check whether the read data can pass Error Correcting Code (ECC) verification, or check whether its number of ECC bits is within an acceptable range. If a detection result of a certain physical page meets a preset condition, it is determined to be a qualified physical page.

Next, in step S320, the memory controller 210 determines whether the operating mode of the first bad block is the lowest storage mode. In this embodiment, the memory controller 210 regards the Single-Level Cell (SLC) mode as the lowest storage mode. If the current operating mode of the first bad block is the SLC mode, the process proceeds to step S340; if the current operating mode of the first bad block is not the SLC mode (for example, a storage mode such as a TLC mode or an MLC mode), the process proceeds to step S330.

In step S330, the memory controller 210 determines whether the total storage capacity after adjusting the first bad block to a next-level storage mode is less than the total storage capacity of the obtained plurality of qualified physical pages. For example, if the first bad block is currently in a TLC mode, the memory controller 210 calculates the storage capacity after adjusting it to an MLC mode and compares it with the total capacity of the current qualified physical pages. If the adjusted storage capacity is less than the total capacity of the qualified physical pages, it indicates that directly adjusting the storage mode will cause a loss of available storage space, and in this case, the process proceeds to step S340; if the adjusted storage capacity is not less than the total capacity of the qualified physical pages, it indicates that adjusting the storage mode is a feasible option, and in this case, the process proceeds to step S350. In other words, this step allows the memory controller to select a method that can preserve more storage space to perform bad block processing, so as to further improve the utilization efficiency of the storage space.

In step S340, the memory controller 210 determines that the operating mode of the first bad block is not adjustable. In this case, the memory controller 210 will instead adopt the method of using spare page groups to utilize these qualified physical pages.

In step S350, the memory controller 210 determines that the operating mode of the first bad block is adjustable. This indicates that the memory controller 210 can efficiently perform a storage mode downgrading operation on the bad block to provide available adjusted blocks for the subsequent construction of a virtual spare block.

Through this determination method, the memory controller 210 can, on the premise of ensuring that the storage capacity is fully utilized, select the most suitable processing solution for each bad block, either by adjusting its operating mode to a lower storage mode for continued use, or by extracting the qualified physical pages therein to form a spare page group.

FIG. 4 is a schematic flowchart of a method for determining whether the operating mode of a first bad block is adjustable according to yet another embodiment of the present disclosure.

Referring to FIG. 4, in another embodiment, the memory controller 210 may adopt a more direct manner to determine whether the operating mode of a first bad block is adjustable.

In step S410, the memory controller 210 determines whether an operating mode of a first bad block is a lowest storage mode. Specifically, the memory controller 210 checks the current operating mode of the first bad block: if the first bad block currently adopts the Single-Level Cell (SLC) mode, it is regarded as the lowest storage mode; if the first bad block currently adopts the Triple-Level Cell (TLC) mode or the Multi-Level Cell (MLC) mode, it is regarded as a degradable storage mode.

In step S420, if the operating mode of the first bad block is the SLC mode, the memory controller 210 determines that the operating mode of the first bad block is not adjustable. In this case, the memory controller 210 will instead detect the availability of each physical page in the bad block, in preparation for subsequent extraction of qualified physical pages to construct a spare page group.

In step S430, if the operating mode of the first bad block is not the SLC mode, the memory controller 210 determines that the operating mode of the first bad block is adjustable. At this time, the memory controller 210 may perform a storage mode downgrading operation on the bad block, for example, adjusting the TLC mode to the MLC mode, or adjusting the MLC mode to the SLC mode, so as to attempt to continue using the physical block at a lower storage density.

Through this simplified determination method, the memory controller 210 can quickly determine the processing direction for a bad block, improving the efficiency of the operating mode adjustment determination. For a bad block whose operating mode is already the SLC mode, the process directly enters the qualified physical page extraction process; for a bad block with a higher storage density operating mode, priority is given to attempting to continue utilization through downgrading.

It should be noted that, in another embodiment, the memory controller 210, under certain specific circumstances, may choose to directly downgrade the operating mode of a first bad block from the Triple-Level Cell (TLC) mode to the Single-Level Cell (SLC) mode, without first attempting the Multi-Level Cell (MLC) mode. For example, when the memory controller 210 detects that the read latency of the first bad block has exceeded a second preset read latency threshold (the threshold is higher than a first preset read latency threshold), or its number of ECC bits is close to but has not yet exceeded a maximum allowable number of ECC bits, considering that the performance degradation of the first bad block is relatively severe, it may still be unable to work stably if downgraded to the MLC mode, and at this time, the memory controller 210 may directly downgrade it to the more stable SLC mode. Alternatively, when the memory controller 210 detects that the number of original spare blocks in the Over-Provisioning Space is lower than a preset remaining quantity threshold, in order to improve the success rate of subsequent bad block replacement operations as much as possible, the memory controller 210 may also choose to directly downgrade the first bad block to the SLC mode to obtain more reliable storage space.

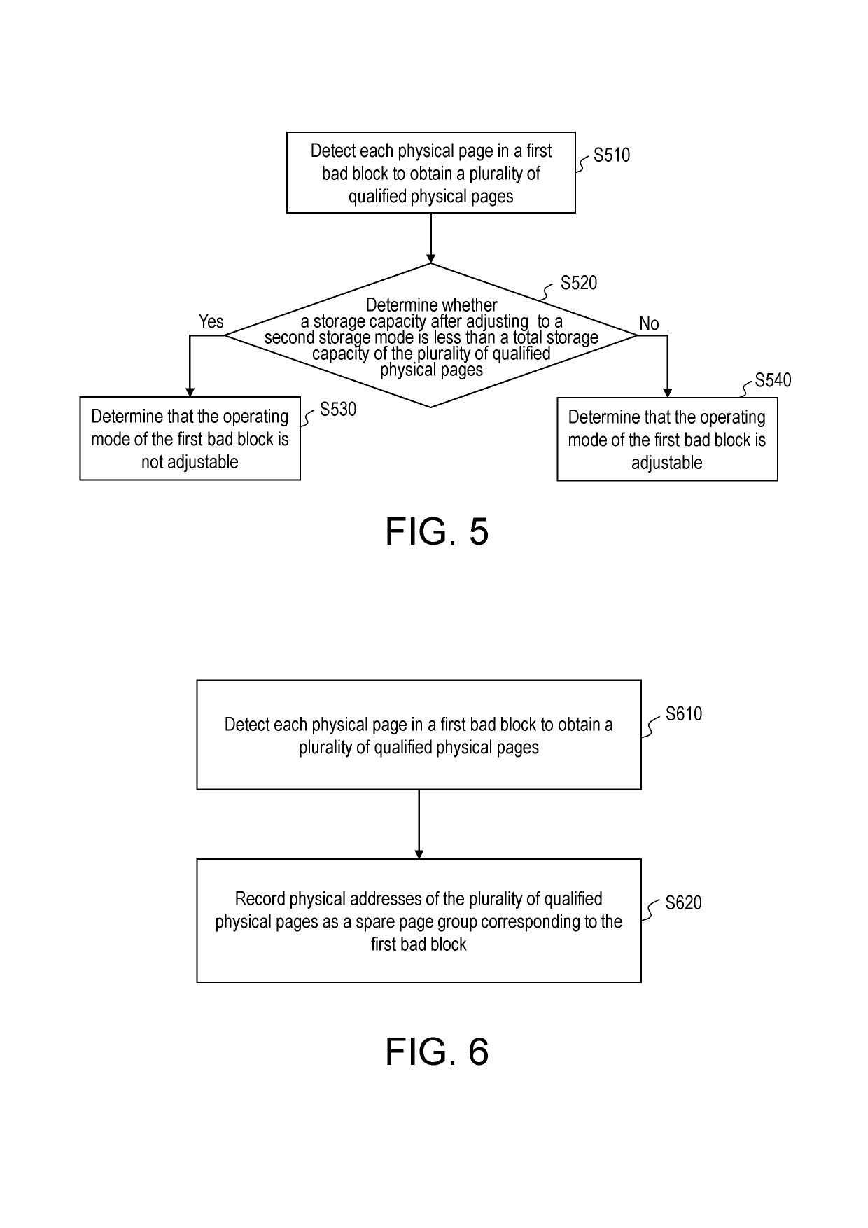

FIG. 5 is a schematic flowchart of a method for determining whether the operating mode of a first bad block is adjustable according to still another embodiment of the present disclosure.

Referring to FIG. 5, in still another embodiment, the memory controller 210 may determine whether the operating mode of a first bad block is adjustable according to the total storage capacity of qualified physical pages in the first bad block.

In step S510, the memory controller 210 detects each physical page in a first bad block to obtain a plurality of qualified physical pages.

In step S520, the memory controller 210 determines whether the storage capacity after adjusting a first bad block to a second storage mode is less than the total storage capacity of the plurality of qualified physical pages. For example, when the first bad block is currently in the Triple-Level Cell (TLC) mode, the memory controller 210 calculates the total storage capacity after adjusting it to the Multi-Level Cell (MLC) mode, and compares it with the total storage capacity that can be provided by the currently identified qualified physical pages.

In step S530, if the adjusted storage capacity is less than the total storage capacity of the qualified physical pages, the memory controller 210 determines that the operating mode of the first bad block is not adjustable. This situation indicates that it is more suitable to directly record these qualified physical pages as a spare page group at this time.

In step S540, if the adjusted storage capacity is not less than the total storage capacity of the qualified physical pages, the memory controller 210 determines that the operating mode of the first bad block is adjustable.

Through this determination method based on storage capacity comparison, the memory controller 210 can select a more effective data preservation method between the two solutions of operating mode adjustment and spare page group extraction, thereby maximizing the utilization of the remaining available storage resources.

FIG. 6 is a schematic flowchart of a processing method when the operating mode of a first bad block is not adjustable according to an embodiment of the present disclosure.

Referring to FIG. 6, in an embodiment, when the operating mode of a first bad block is not adjustable (for example, it is already in the single-level cell mode, or the adjusted storage capacity is insufficient to preserve the current valid data), the memory controller 210 may process the bad block through the following steps:

In step S610, the memory controller 210 detects each physical page in a first bad block to obtain a plurality of qualified physical pages.

Specifically, the memory controller 210 may evaluate the availability of a physical page in one of several ways: in a first way, the memory controller 210 may write test data to each physical page and attempt to read it, and determine the availability of the physical page by comparing whether the written and read data are consistent; in a second way, the memory controller 210 may detect the number of Error Correction Code (ECC) bits when reading data, and if the number of ECC bits of the data read from a certain physical page does not exceed a preset ECC bit threshold (for example, the number of ECC bits per 2KB of data is within an acceptable range), then the physical page is determined to be a qualified physical page; in a third way, the memory controller 210 may also measure the read latency of each physical page, and if the read latency does not exceed a preset read latency threshold, the physical page may also be determined to be a qualified physical page.

It should be noted that, if the memory controller 210 has already obtained the plurality of qualified physical pages in the first bad block in a previous processing procedure, step S610 may be skipped, and step S620 is directly executed.

In step S620, the memory controller 210 records the physical addresses of the obtained plurality of qualified physical pages as a spare page group corresponding to the first bad block. Specifically, the memory controller 210 creates a new spare page group record entry in the spare page group list, and the record entry includes: identification information of the spare page group, identification information of the corresponding first bad block, physical address information of each qualified physical page, and the like. By establishing and maintaining such a record, the memory controller 210 not only preserves the location information of the qualified physical pages, but also establishes a correspondence relationship between the qualified physical pages and the bad block to which they belong, which facilitates quick location and utilization of these still-usable physical pages in the subsequent construction of a virtual spare block. In addition, the memory controller 210 may also include performance parameters of each qualified physical page (such as read latency, number of ECC bits, etc.) in the record entry, so as to preferentially select physical pages with better performance when subsequently selecting qualified physical pages to form a virtual spare block.

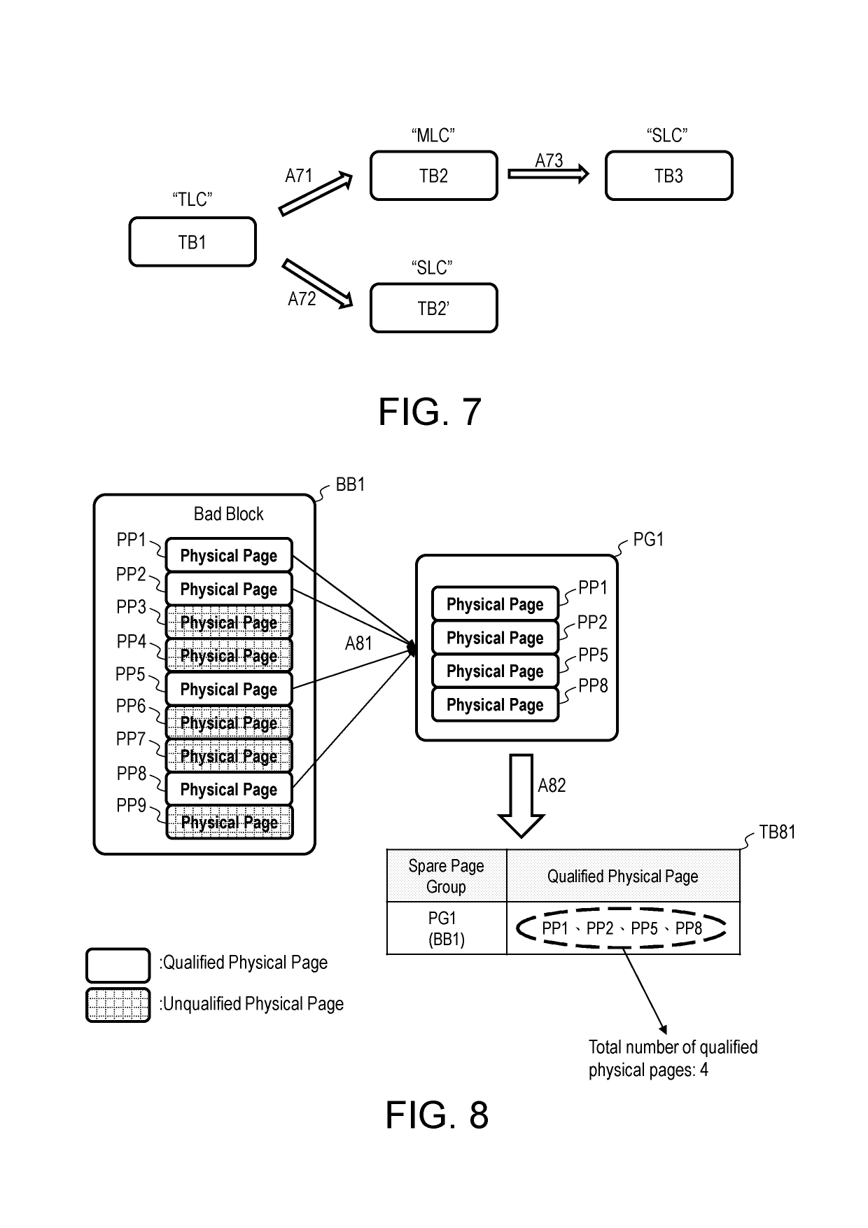

FIG. 7 is a schematic diagram of an operating mode adjustment process of a physical block according to an embodiment of the present disclosure.

Referring to FIG. 7, FIG. 7 illustrates a plurality of possible paths for the memory controller 210 to perform operating mode adjustment on a first bad block TB1. In an embodiment, the first storage mode of the first bad block TB1 being a Triple-Level Cell (TLC) mode is taken as an example for description, but it should be understood that the first storage mode may also be another multi-level storage mode such as a Multi-Level Cell (MLC) mode or a Quad-Level Cell (QLC) mode.

As shown by arrow A71, the memory controller 210 may choose to adjust the operating mode of the first bad block TB1 from the TLC mode to the MLC mode to obtain a second bad block TB2. In this case, since the storage density of the MLC mode is lower than that of the TLC mode, each memory cell only needs to store two bits of data, so the storage reliability of data can be improved at the expense of some storage capacity.

As shown by arrow A72, the memory controller 210 may also choose to directly adjust the operating mode of the first bad block TB1 from the TLC mode to the Single-Level Cell (SLC) mode to obtain a second bad block TB2'. Although this adjustment method will cause the storage capacity to be reduced to one-third of the original, since the SLC mode has the highest storage reliability and the lowest error rate, it is suitable for the situation where the performance of the first bad block TB1 has degraded more severely.

In addition, as shown by arrow A73, for the second bad block TB2 that has been adjusted to the MLC mode, if its detection result in the MLC mode is still unqualified, the memory controller 210 may further adjust its operating mode from the MLC mode to the SLC mode to obtain a third bad block TB3. This step-by-step adjustment method enables the memory controller 210 to flexibly select the most suitable storage mode according to the actual condition of the bad block.

In a specific implementation process, the memory controller 210 needs to perform an availability detection on the adjusted second bad block TB2. The memory controller 210 first writes preset test data to the second bad block TB2, and then attempts to read the test data from the second bad block TB2. If the memory controller 210 can successfully read the test data, and the read data is consistent with the written data, it is determined that a detection result of the second bad block TB2 is qualified; if the read fails, or the read data is inconsistent with the written data, it is determined that the detection result of the second bad block TB2 is unqualified.

When the detection result of the second bad block TB2 in the second storage mode (e.g., the MLC mode) is unqualified, and its operating mode is still adjustable (i.e., not currently in the lowest storage mode), the memory controller 210 performs a further operating mode adjustment. As shown in FIG. 7, the memory controller 210 adjusts the operating mode of the second bad block TB2 from the second storage mode (the MLC mode) to a third storage mode (the SLC mode) to obtain a third bad block TB3. It should be noted here that the storage capacity of each second memory cell of the second bad block TB2 in the second storage mode (dual-bit) is greater than the storage capacity of each third memory cell of the third bad block TB3 in the third storage mode (single-bit). After the adjustment is completed, the memory controller 210 detects the third bad block TB3, and if the detection result is qualified, the third bad block TB3 is recorded in the adjusted block list as another adjusted block for subsequent use in constructing a virtual spare block.

In an embodiment, if the detection result of the third bad block TB3 in the SLC mode is still unqualified, since it is already in the lowest storage mode, the memory controller 210 will instead adopt a more refined management method. Specifically, the memory controller 210 detects each physical page in the third bad block TB3 page by page to identify the qualified physical pages that can still be used normally. For those physical pages that can pass the test and whose performance parameters are within an acceptable range, the memory controller 210 records their physical addresses in the spare page group list. Although this page-level refined management method may bring a certain management overhead, it can maximize the utilization of the parts of the storage space that can still work properly, further improving the utilization efficiency of bad blocks. When a sufficient number of qualified physical pages have been accumulated, the memory controller 210 may combine these physical pages into a virtual spare block to continue providing available spare storage space for the storage device.

Through this operating mode adjustment mechanism, the memory controller 210 can find a balance between storage capacity and data reliability, and maximize the service life of each physical block. For the adjusted block after adjustment, the memory controller 210 records it in the adjusted block list for subsequent use in constructing a virtual spare block.

In an embodiment, when the memory controller 210 has already accumulated a plurality of spare page groups in the spare page group list, these spare page groups may be combined into a virtual spare block. Specifically, the memory controller 210 first selects a plurality of target spare page groups from these spare page groups according to a preset storage capacity (for example, the storage capacity of a physical block in a TLC mode) and the respective storage capacities of the plurality of recorded spare page groups. When selecting, the memory controller 210 ensures that the total storage capacity of these target spare page groups is equal to the preset storage capacity.

For example, if a physical block in a TLC mode contains 144 physical pages, and the current spare page group list records a plurality of spare page groups from different physical blocks: a first spare page group contains 60 qualified physical pages, a second spare page group contains 48 qualified physical pages, a third spare page group contains 36 qualified physical pages, and a fourth spare page group contains 25 qualified physical pages. The memory controller 210 may select the first, second, and third spare page groups among them as target spare page groups, because their total number of qualified physical pages (60+48+36=144) is exactly equal to the number of physical pages required by the preset storage capacity, so as to completely construct a virtual spare block. Such a selection not only ensures the full utilization of the storage capacity, but also facilitates subsequent data mapping and management.

It is worth noting that, in another embodiment, the memory controller 210 may also choose to construct a virtual spare block of a smaller capacity based on the number of qualified physical pages in the current spare page groups. For example, if a physical block in an SLC mode contains 48 physical pages, and the current spare page group list records the following spare page groups: a first spare page group contains 30 qualified physical pages, a second spare page group contains 18 qualified physical pages, and a third spare page group contains 25 qualified physical pages. The memory controller 210 may select the first and second spare page groups among them as target spare page groups, because their total number of qualified physical pages (30+18=48) is exactly equal to the preset storage capacity of a physical block in the SLC mode. Although the storage capacity of the virtual spare block constructed through this combination method (adjusted blocks of SLC size may also be used) is smaller, in some application scenarios where only data blocks of SLC size are required (for example, storing system parameters or log data that need frequent updates), more stable and suitable storage space can be provided. This flexible combination strategy enables the memory controller 210 to more effectively utilize available storage resources according to actual application requirements.

After the target spare page groups are selected, the memory controller 210 combines these target spare page groups into another virtual spare block, and incorporates the virtual spare block into the Over-Provisioning Space of the rewritable non-volatile memory module 220. Meanwhile, the memory controller 210 establishes a mapping relationship between the virtual spare block and these target spare page groups in the virtual spare block mapping table. This mapping relationship includes not only identification information of the virtual spare block, but also records identification information of each target spare page group constituting the virtual spare block, and physical address information of each qualified physical page in these target spare page groups, so as to correctly access the actual physical locations during subsequent data access operations.

FIG. 8 is a schematic diagram of a qualified physical page extraction process in a bad block according to an embodiment of the present disclosure.

Referring to FIG. 8, FIG. 8 illustrates a process of the memory controller 210 recording a spare page group. In this embodiment, a physical block BB1 having 9 physical pages (PP1 to PP9) is taken as an example for description, but it should be understood that a physical block may have other numbers of physical pages, for example, 64, 128, or 256 physical pages, etc.

As shown in FIG. 8, the memory controller 210 first detects the availability of each physical page in the physical block BB1. The detection results show that physical pages PP1, PP2, PP5, and PP8 are qualified physical pages, while physical pages PP3, PP4, PP6, PP7, and PP9 are unqualified physical pages (represented by grid filling in the figure).

As shown by arrow A81, the memory controller 210 organizes the detected qualified physical pages into a spare page group PG1. As shown by arrow A82, the memory controller 210 creates a new record entry in the spare page group list TB81, and the record entry includes: identification information of the spare page group (PG1), corresponding physical block identification information (BB1), and physical address information of the qualified physical pages contained in the spare page group (PP1, PP2, PP5, PP8).

In another embodiment, the memory controller 210 may also record the total number of qualified physical pages of each spare page group in the spare page group list TB81. As shown in FIG. 8, the total number of qualified physical pages of the spare page group PG1 is 4. By recording the number of qualified physical pages, the memory controller 210 can more efficiently manage and utilize these spare page groups. For example, when it is necessary to construct a virtual spare block, the memory controller 210 may quickly screen and combine suitable spare page groups according to the number of qualified physical pages. If a certain spare page group has a larger number of qualified physical pages, the memory controller 210 may preferentially select that spare page group, so as to reduce the number of spare page groups that need to be combined, thereby reducing management overhead. In addition, the information on the number of qualified physical pages can also help the memory controller 210 to evaluate the currently available storage resources and reasonably plan subsequent data storage strategies.

In another embodiment, when the memory controller 210 cannot select a combination of target spare page groups whose total storage capacity is exactly equal to the preset storage capacity from the current spare page group list, a plurality of strategies may be adopted to handle this situation.

For example, if a physical block in a TLC mode contains 144 physical pages, and the spare page groups recorded in the current spare page group list respectively contain: 50, 45, and 40 qualified physical pages, even if all spare page groups are selected, their total number of qualified physical pages (135) is still less than the number of physical pages required by the preset storage capacity (144). In this case, the memory controller 210 may choose to continue waiting for new spare page groups. Specifically, the memory controller 210 may set a waiting threshold time, and within this time, continue to detect other physical blocks in order to obtain more spare page groups.

In addition, in yet another embodiment, the memory controller 210 may also prioritize the processing of spare page groups containing more qualified physical pages. When a new physical block is detected and a new spare page group is obtained, the memory controller 210 preferentially selects the spare page groups with a larger number of qualified physical pages for combination, thereby reducing the number of spare page groups that need to be managed and reducing management overhead. Meanwhile, for spare page groups with a smaller remaining capacity, they may be kept in the spare page group list to await subsequent combination with other spare page groups.

On the other hand, in an embodiment, the memory controller 210 may also combine these spare page groups into a virtual adjusted block of a smaller capacity. For example, when the total number of qualified physical pages (135) is close to but does not reach the preset storage capacity of a physical block in a TLC mode (144), the memory controller 210 may choose to combine these spare page groups into a virtual adjusted block with a capacity equivalent to that of a physical block in an MLC mode (requiring 96 physical pages). In this case, the memory controller 210 records this virtual adjusted block in the adjusted block list and establishes a mapping relationship between it and the corresponding spare page groups. When a sufficient number of virtual adjusted blocks are subsequently accumulated (for example, two virtual adjusted blocks of MLC capacity, or three virtual adjusted blocks of SLC capacity), the memory controller 210 may then combine them into a virtual spare block with a capacity equal to the preset storage capacity. Through this step-by-step combination method, the memory controller 210 can not only utilize existing storage resources more timely, but also maintain a management mechanism consistent with the operating mode adjustment solution.

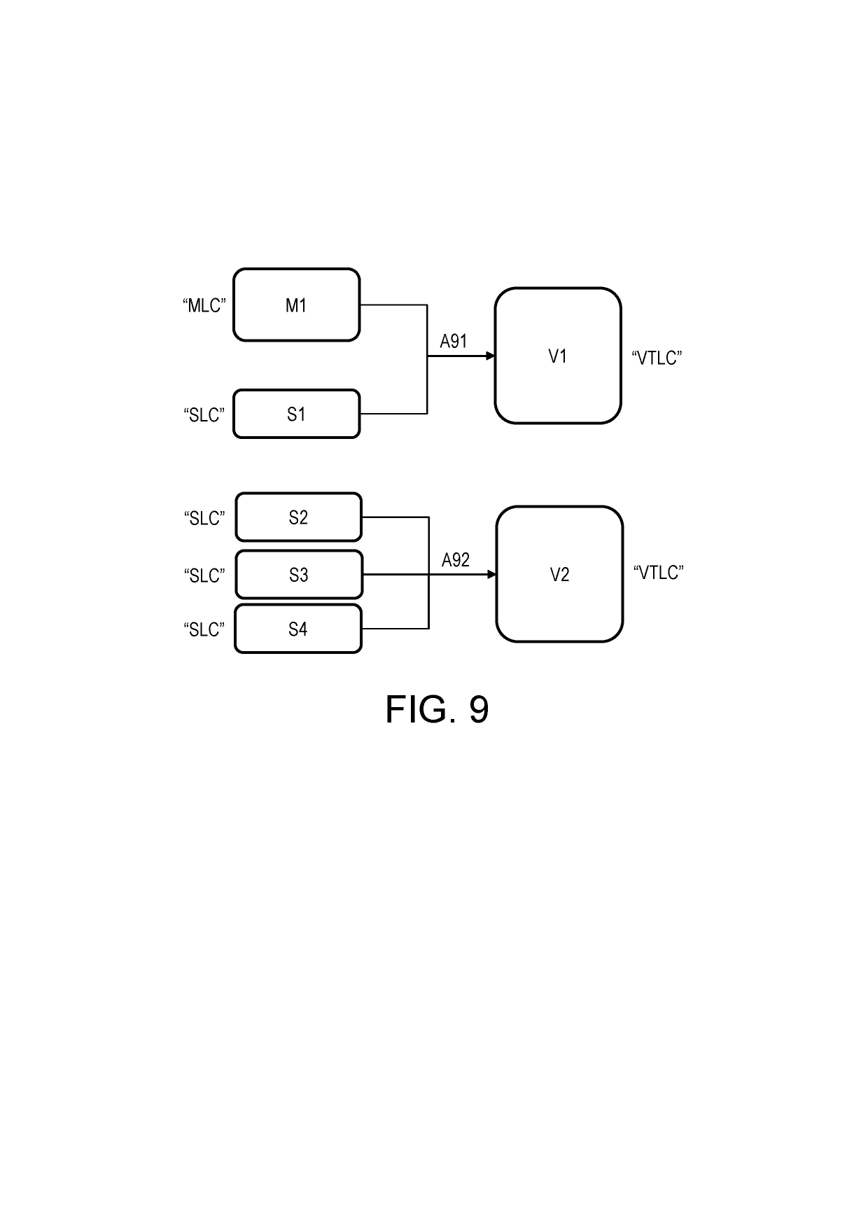

FIG. 9 is a first exemplary schematic diagram of a construction process of a virtual spare block according to an embodiment of the present disclosure.

Referring to FIG. 9, FIG. 9 illustrates a process of the memory controller 210 constructing a virtual spare block in different ways. In an embodiment, as shown by arrow A91, the memory controller 210 combines an adjusted block M1 in an MLC mode and an adjusted block S1 in an SLC mode into a virtual spare block V1. Since in the MLC mode, a memory cell can store two bits of data, while in the SLC mode, a memory cell stores only one bit of data, by combining one adjusted block in the MLC mode and one adjusted block in the SLC mode, the memory controller 210 can obtain a virtual spare block V1 with a storage capacity equivalent to that of a physical block in a TLC mode (indicated as "VTLC" in FIG. 9, representing that it has a storage capacity comparable to the TLC mode).

As shown by arrow A92, the memory controller 210 may also adopt another combination method, combining three adjusted blocks S2, S3, and S4 in the SLC mode into a virtual spare block V2. Since the storage capacity of each adjusted block in the SLC mode is one-third of that of a physical block in the TLC mode, by combining three adjusted blocks in the SLC mode, a virtual spare block V2 with a storage capacity equivalent to that of a physical block in the TLC mode can also be obtained.

During the process of constructing a virtual spare block, the memory controller 210 records these mapping relationships in the virtual spare block mapping table. For example, for the virtual spare block V1, the memory controller 210 records that it is composed of the adjusted blocks M1 and S1; for the virtual spare block V2, it records that it is composed of the adjusted blocks S2, S3, and S4. Through this mapping mechanism, when a data access operation needs to be performed on a virtual spare block, the memory controller 210 can accurately find the physical location where the data is actually stored.

Through this flexible combination method, the memory controller 210 can select the most suitable combination scheme to construct a virtual spare block according to the operating modes of the existing adjusted blocks in the adjusted block list, so as to efficiently utilize these storage spaces that are still usable after being downgraded.

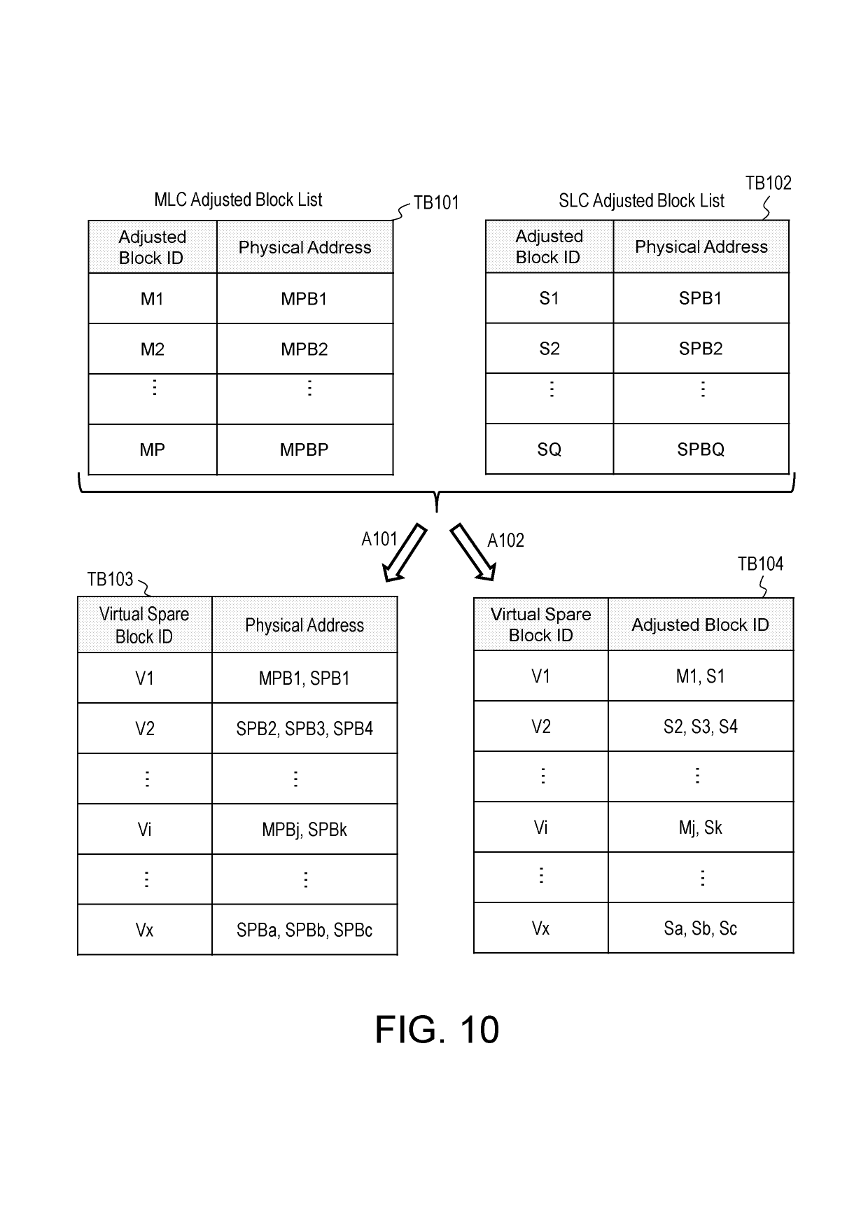

FIG. 10 is a schematic diagram of an adjusted block list and a virtual spare block mapping table according to an embodiment of the present disclosure.

Referring to FIG. 10, in an embodiment, first, the memory controller 210 respectively records adjusted blocks of different operating modes in corresponding lists. As shown in FIG. 10, the memory controller 210 records adjusted blocks in an MLC mode in an MLC adjusted block list TB101, with each record entry including an adjusted block ID (e.g., M1, M2, etc.) and its corresponding physical address (e.g., MPB1, MPB2, etc.); similarly, adjusted blocks in an SLC mode are recorded in an SLC adjusted block list TB102, with a record entry including an adjusted block ID (e.g., S1, S2, etc.) and a corresponding physical address (e.g., SPB1, SPB2, etc.).

As shown by arrow A101, when the memory controller 210 combines adjusted blocks into a virtual spare block, a mapping table TB103 that directly records physical addresses may be established. In the mapping table TB103, the memory controller 210 records each virtual spare block ID (e.g., V1, V2, etc.) and its corresponding specific physical address. For example, the physical address corresponding to the virtual spare block V1 is "MPB1, SPB1", indicating that the virtual spare block is composed of an adjusted block in an MLC mode with the physical address MPB1 and an adjusted block in an SLC mode with the physical address SPB1. As another example, the physical address corresponding to the virtual spare block V2 is "SPB2, SPB3, SPB4", indicating that the virtual spare block is composed of three adjusted blocks in the SLC mode, and the physical addresses of these three adjusted blocks in the SLC mode are "SPB2, SPB3, SPB4", respectively.

In another embodiment, as shown by arrow A102, the memory controller 210 may also establish another mapping table TB104 based on adjusted block IDs. In this mapping table, the memory controller 210 records the correspondence relationship between virtual spare block IDs and adjusted block IDs. For example, the adjusted block IDs corresponding to the virtual spare block V1 are "M1, S1", indicating that the virtual spare block is composed of an adjusted block in an MLC mode with the ID M1 and an adjusted block in an SLC mode with the ID S1. As another example, the adjusted block IDs corresponding to the virtual spare block V2 are "S2, S3, S4", indicating that the virtual spare block is composed of three adjusted blocks in the SLC mode with the IDs S2, S3, and S4, respectively.

In another embodiment, the memory controller 210 may also establish both types of mapping tables simultaneously. By maintaining these two different forms of mapping tables, the memory controller 210 may select a suitable mapping relationship according to actual needs. For example, when it is necessary to directly access a physical address, the mapping table TB103 may be used to achieve precise locating of data for access; when it is necessary to query the composition structure of a virtual spare block, the mapping table TB104 may be used to quickly query the general composition of the virtual spare block. This dual mapping mechanism not only improves the flexibility of data management, but also provides more convenience for subsequent data access operations.

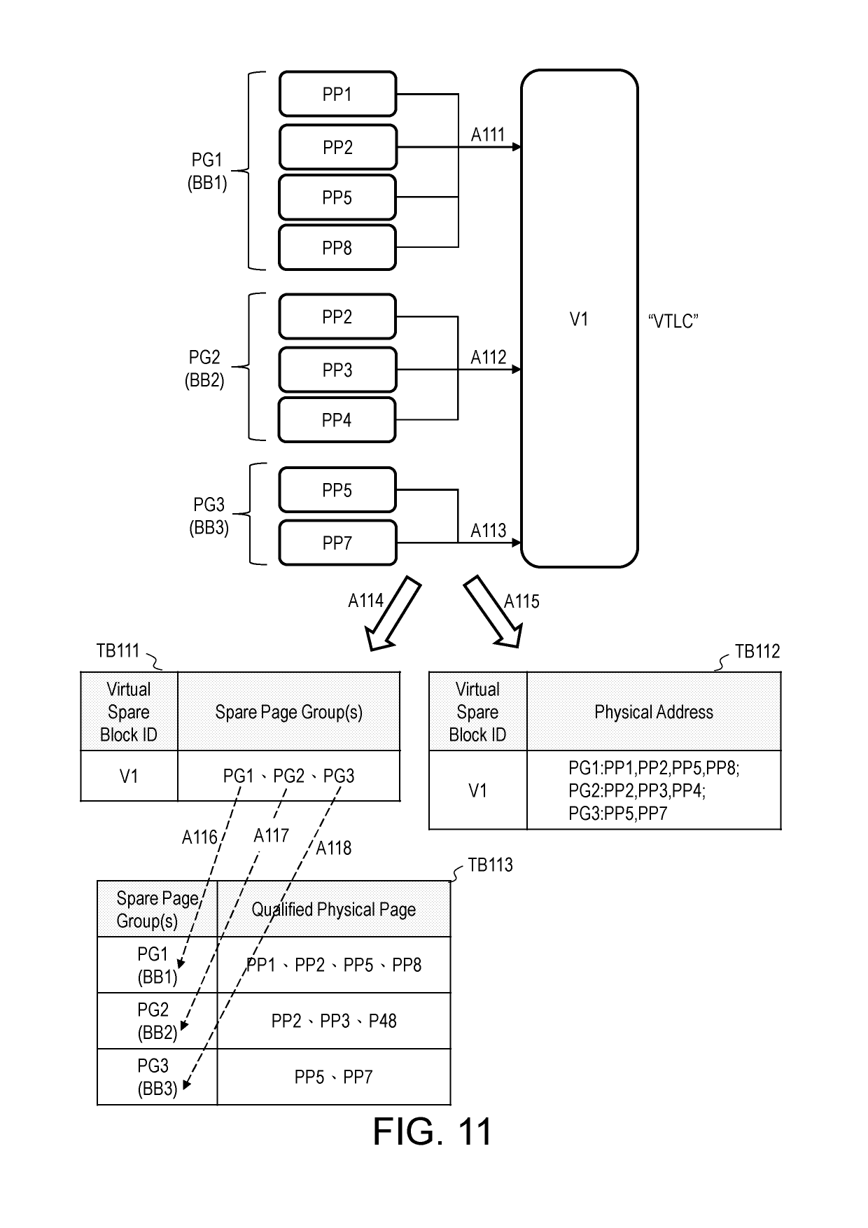

FIG. 11 is a second exemplary schematic diagram of a construction process of a virtual spare block according to an embodiment of the present disclosure.

Referring to FIG. 11, as shown by arrows A111, A112, and A113, the memory controller 210 respectively extracts qualified physical pages from different physical blocks BB1, BB2, and BB3 to form spare page groups PG1, PG2, and PG3. Among them, the spare page group PG1 includes physical pages PP1, PP2, PP5, and PP8; the spare page group PG2 includes physical pages PP2, PP3, and PP4; and the spare page group PG3 includes physical pages PP5 and PP7. When the total number of qualified physical pages of these spare page groups reaches a preset storage capacity (for example, equivalent to the storage capacity of a physical block in a TLC mode), the memory controller 210 combines them into a virtual spare block V1 (indicated as "VTLC" in FIG. 11, representing that it has a storage capacity comparable to the TLC mode).

As shown by arrow A114, the memory controller 210 establishes a correspondence relationship between a virtual spare block ID and the spare page groups that constitute the virtual spare block, and records the relationship in a mapping table TB111. For example, the spare page group(s) corresponding to the virtual spare block V1 is "PG1, PG2, PG3", indicating that the virtual spare block is formed by combining these three spare page groups.

As shown by arrows A116, A117, and A118, the memory controller 210 also maintains a spare page group list TB113 for recording detailed information of each spare page group. The list includes identification information of the spare page groups (e.g., PG1, PG2, PG3), corresponding physical block identification information (e.g., BB1, BB2, BB3), and information of qualified physical pages contained in each spare page group. Through this multi-level recording of mapping relationships, the memory controller 210 can not only track the composition structure of each virtual spare block, but also accurately locate specific physical page positions, thereby achieving refined management of storage resources.

In addition, in another embodiment, as shown by arrow A115, the memory controller 210 also establishes another more detailed mapping table TB112, recording the correspondence relationship between a virtual spare block ID and specific physical page addresses. For example, for the virtual spare block V1, its physical address is recorded as "PG1: PP1, PP2, PP5, PP8; PG2: PP2, PP3, PP4; PG3: PP5, PP7", which clearly identifies the specific physical pages contained in each spare page group.

This detailed recording method has a plurality of advantages: first, when the memory controller 210 needs to perform a data write operation on a virtual spare block, it can directly access data according to the physical page addresses without requiring additional address translation steps, thereby improving data access efficiency; second, since the location of each qualified physical page is clearly recorded, the memory controller 210 can achieve load balancing when performing data writing, avoiding overuse of certain physical pages; in addition, when some physical pages become abnormal, the memory controller 210 can quickly locate the problematic position and timely adjust the composition of the virtual spare block to ensure the reliability of data storage.

Finally, this embodiment also provides a computer program product, including computer-readable code, or a non-volatile computer-readable storage medium carrying computer-readable code. When the computer-readable code is run in a processor of a host system, the processor executes the process steps of the above-mentioned memory management method and implements the functions of the memory controller. The computer program product may be specifically implemented by hardware, firmware, software, or a combination thereof. In an optional embodiment, the computer program product is specifically embodied as a computer storage medium, and in another optional embodiment, the computer program product is specifically embodied as a software product, such as a software development kit (SDK), and so on.

Based on the above, the memory management method and the memory controller provided by the embodiments of the present disclosure can achieve the following effects:

By adjusting the operating mode of a performance-degraded physical block from a high storage density to a low storage density (for example, from TLC to MLC or SLC) and verifying its availability after the adjustment, memory cells that cannot work properly in the original operating mode but are still usable after being downgraded can be fully utilized. Meanwhile, the memory controller 210 adopts a step-wise adjustment strategy (for example, first downgrading from TLC to MLC, and then to SLC if necessary), which can find an optimal balance between storage capacity and data reliability.

Moreover, the memory controller 210 achieves flexible management of the downgraded storage space by establishing data structures such as an adjusted block list, a spare page group list, and a virtual spare block mapping table. For example, the memory controller 210 may combine a plurality of adjusted blocks into a virtual spare block, or extract qualified physical pages from a bad block in the lowest storage mode to form a spare page group, and then combine a plurality of spare page groups into a virtual spare block, so as to effectively supplement the resources of the Over-Provisioning Space of the rewritable non-volatile memory module 220.

In addition, by simultaneously maintaining a dual mapping relationship based on adjusted block IDs and specific physical addresses in the virtual spare block mapping table, not only is data access efficiency improved, but refined management of storage resources is also achieved. When some memory cells become abnormal, the memory controller 210 can quickly perform locating and adjustment to ensure the stable operation of the storage device.

In summary, the embodiments of the present disclosure, by performing flexible operating mode adjustment and refined management on bad blocks, slow down the consumption rate of the Over-Provisioning Space resources and effectively extend the service life of the storage device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method, adapted for a storage device configured with a rewritable non-volatile memory module, the method comprising:
obtaining a first bad block;
determining whether the operating mode of the first bad block is adjustable;
if the operating mode of the first bad block is adjustable:
adjusting the operating mode of the first bad block from a first storage mode to a second storage mode to obtain a second bad block, wherein a first storage capacity of each first memory cell of the first bad block in the first storage mode is greater than a second storage capacity of each second memory cell of the second bad block in the second storage mode;
detecting the second bad block in the second storage mode;
if a detection result of the second bad block is qualified, designating the second bad block as an adjusted block and recording the adjusted block;
according to a preset storage capacity and respective storage capacities of a plurality of recorded adjusted blocks, obtaining a plurality of target adjusted blocks from the plurality of adjusted blocks, and combining the plurality of target adjusted blocks into a virtual spare block to be incorporated into the Over-Provisioning Space of the rewritable non-volatile memory module, wherein the storage capacity of the virtual spare block is equal to the preset storage capacity.

2. The memory management method according to claim 1, wherein the step of obtaining the first bad block comprises:
detecting whether a physical block in a data area of the rewritable non-volatile memory module meets a bad block determination criterion; and
if the physical block in the data area meets the bad block determination criterion, determining the physical block as the first bad block.

3. The memory management method according to claim 1, wherein before adjusting the operating mode of the first bad block from the first storage mode to the second storage mode, the method further comprises:
obtaining a first spare block or a first virtual spare block from the Over-Provisioning Space as a first data block; and
migrating data in the first bad block to the first data block, and incorporating the first data block into a data area of the rewritable non-volatile memory module.

4. The memory management method according to claim 1, wherein the step of, according to the preset storage capacity and respective storage capacities of the plurality of recorded adjusted blocks, obtaining the plurality of target adjusted blocks from the plurality of adjusted blocks, and combining the plurality of target adjusted blocks into the virtual spare block to be incorporated into the Over-Provisioning Space of the rewritable non-volatile memory module, comprises:
from the plurality of recorded adjusted blocks, based on the preset storage capacity and the respective storage capacities of the plurality of recorded adjusted blocks, selecting the plurality of target adjusted blocks, so as to cause a total storage capacity of the plurality of target adjusted blocks to be equal to the preset storage capacity;
combining the plurality of target adjusted blocks into the virtual spare block; and
incorporating the virtual spare block into the Over-Provisioning Space, and establishing a mapping relationship between the virtual spare block and the plurality of target adjusted blocks.

5. The memory management method according to claim 1, wherein the step of determining whether the operating mode of the first bad block is adjustable comprises:
determining whether the operating mode of the first bad block is a lowest storage mode;
if the operating mode of the first bad block is not the lowest storage mode, determining that the operating mode of the first bad block is adjustable;
if the operating mode of the first bad block is the lowest storage mode, determining that the operating mode of the first bad block is not adjustable.

6. The memory management method according to claim 5, wherein if the operating mode of the first bad block is not adjustable, the method further comprises:
recording physical addresses of a plurality of qualified physical pages in the first bad block as a spare page group corresponding to the first bad block.

7. The memory management method according to claim 6, wherein the method further comprises:
according to the preset storage capacity and respective storage capacities of a plurality of recorded spare page groups, selecting, from the plurality of spare page groups, a plurality of target spare page groups, so as to cause a total storage capacity of the plurality of target spare page groups to be equal to the preset storage capacity; and
combining the plurality of target spare page groups into another virtual spare block to be incorporated into the Over-Provisioning Space of the rewritable non-volatile memory module, and establishing a mapping relationship between the another virtual spare block and the plurality of target spare page groups.

8. The memory management method according to claim 1, wherein the step of determining whether the operating mode of the first bad block is adjustable comprises:
detecting each physical page in the first bad block to obtain a plurality of qualified physical pages;
if a total storage capacity of the second bad block in the second storage mode is less than a total storage capacity of the plurality of qualified physical pages of the first bad block, determining that the operating mode of the first bad block is not adjustable, and recording physical addresses of the plurality of qualified physical pages as a spare page group corresponding to the first bad block; and
if the total storage capacity of the second bad block in the second storage mode is not less than the total storage capacity of the plurality of qualified physical pages of the first bad block, determining that the operating mode of the first bad block is adjustable.

9. The memory management method according to claim 1, wherein the step of detecting the second bad block in the second storage mode comprises:
writing test data to the second bad block, and reading the test data from the second bad block;
if a read result of the test data is successful, determining that a detection result of the second bad block is qualified; and
if the read result of the test data is unsuccessful, determining that the detection result of the second bad block is unqualified.

10. The memory management method according to claim 9, wherein the method further comprises:
if the detection result of the second bad block in the second storage mode is unqualified and the operating mode of the second bad block is adjustable:
adjusting the operating mode of the second bad block from the second storage mode to a third storage mode to obtain a third bad block, wherein a second storage capacity of each second memory cell of the second bad block in the second storage mode is greater than a third storage capacity of each third memory cell of the third bad block in the third storage mode; and
if a detection result of the third bad block is qualified, recording the third bad block as another adjusted block.

11. A memory controller for controlling a storage device configured with a rewritable non-volatile memory module, the memory controller comprising:
a memory interface control circuit, electrically connected to the rewritable non-volatile memory module;
a data management circuit, electrically connected to a connection interface circuit of the storage device, for receiving data and commands from a host system via the connection interface circuit;
a buffer memory, for buffering data; and
a processor, electrically connected to the memory interface control circuit, the data management circuit, and the buffer memory, wherein the processor is configured to:
obtain a first bad block;
determine whether the operating mode of the first bad block is adjustable;
if the operating mode of the first bad block is adjustable:
adjust the operating mode of the first bad block from a first storage mode to a second storage mode to obtain a second bad block, wherein a first storage capacity of each first memory cell of the first bad block in the first storage mode is greater than a second storage capacity of each second memory cell of the second bad block in the second storage mode;
detect the second bad block in the second storage mode;
if a detection result of the second bad block is qualified, designate the second bad block as an adjusted block and record the adjusted block;
according to a preset storage capacity and respective storage capacities of a plurality of recorded adjusted blocks, obtain a plurality of target adjusted blocks from the plurality of adjusted blocks, and combine the plurality of target adjusted blocks into a virtual spare block to be incorporated into the Over-Provisioning Space of the rewritable non-volatile memory module, wherein the storage capacity of the virtual spare block is equal to the preset storage capacity.

12. The memory controller according to claim 11, wherein the bad block determination criterion comprises:
a program/erase cycle count of a physical block exceeding a first preset program/erase threshold;
a number of Error Correction Code (ECC) bits of data in the physical block exceeding a first preset ECC bit threshold;
a read latency of the physical block exceeding a first preset read latency threshold; or
a write failure count of the physical block exceeding a first preset write failure threshold.

13. The memory controller according to claim 11, wherein the processor is further configured to:
before adjusting the operating mode of the first bad block from the first storage mode to the second storage mode:
obtain a first spare block or a first virtual spare block from the Over-Provisioning Space as a first data block; and
migrate data in the first bad block to the first data block, and incorporate the first data block into a data area of the rewritable non-volatile memory module.

14. The memory controller according to claim 11, wherein the step of, according to the preset storage capacity and respective storage capacities of the plurality of recorded adjusted blocks, obtaining the plurality of target adjusted blocks from the plurality of adjusted blocks, and combining the plurality of target adjusted blocks into the virtual spare block to be incorporated into the Over-Provisioning Space of the rewritable non-volatile memory module, comprises:
from the plurality of recorded adjusted blocks, based on the preset storage capacity and the respective storage capacities of the plurality of recorded adjusted blocks, selecting the plurality of target adjusted blocks, so as to cause a total storage capacity of the plurality of target adjusted blocks to be equal to the preset storage capacity;
combining the plurality of target adjusted blocks into the virtual spare block; and
incorporating the virtual spare block into the Over-Provisioning Space, and establishing a mapping relationship between the virtual spare block and the plurality of target adjusted blocks.

15. The memory controller according to claim 11, wherein the step of determining whether the operating mode of the first bad block is adjustable comprises:
determining whether the operating mode of the first bad block is a lowest storage mode;
if the operating mode of the first bad block is not the lowest storage mode, determining that the operating mode of the first bad block is adjustable;
if the operating mode of the first bad block is the lowest storage mode, determining that the operating mode of the first bad block is not adjustable.

16. The memory controller according to claim 15, wherein if the operating mode of the first bad block is not adjustable, the processor is further configured to:
record physical addresses of a plurality of qualified physical pages in the first bad block as a spare page group corresponding to the first bad block.

17. The memory controller according to claim 16, wherein the processor is further configured to:
according to the preset storage capacity and respective storage capacities of a plurality of recorded spare page groups, select, from the plurality of spare page groups, a plurality of target spare page groups, so as to cause a total storage capacity of the plurality of target spare page groups to be equal to the preset storage capacity; and
combine the plurality of target spare page groups into another virtual spare block to be incorporated into the Over-Provisioning Space of the rewritable non-volatile memory module, and establish a mapping relationship between the another virtual spare block and the plurality of target spare page groups.

18. The memory controller according to claim 11, wherein the step of determining whether the operating mode of the first bad block is adjustable comprises:
detecting each physical page in the first bad block to obtain a plurality of qualified physical pages;
if a total storage capacity of the second bad block in the second storage mode is less than a total storage capacity of the plurality of qualified physical pages of the first bad block, determining that the operating mode of the first bad block is not adjustable, and recording physical addresses of the plurality of qualified physical pages as a spare page group corresponding to the first bad block; and
if the total storage capacity of the second bad block in the second storage mode is not less than the total storage capacity of the plurality of qualified physical pages of the first bad block, determining that the operating mode of the first bad block is adjustable.

19. The memory controller according to claim 11, wherein the step of detecting the second bad block in the second storage mode comprises:
writing test data to the second bad block, and reading the test data from the second bad block;
if a read result of the test data is successful, determining that a detection result of the second bad block is qualified; and
if the read result of the test data is unsuccessful, determining that the detection result of the second bad block is unqualified.

20. The memory controller according to claim 19, wherein the processor is further configured to:
if the detection result of the second bad block in the second storage mode is unqualified and the operating mode of the second bad block is adjustable:
adjust the operating mode of the second bad block from the second storage mode to a third storage mode to obtain a third bad block, wherein a second storage capacity of each second memory cell of the second bad block in the second storage mode is greater than a third storage capacity of each third memory cell of the third bad block in the third storage mode; and
if a detection result of the third bad block is qualified, record the third bad block as another adjusted block.
